(19) United States
(12) Patent Application Publication
(10) Pub. No.: US 2005/0161327 A1
(43) Pub. Date: Jul. 28, 2005

(54) Microfluidic device and method for transporting electrically charged substances through a microchannel of a microfluidic device

(76) Inventor: Michele Palmieri, Agrate Brianza (IT)

Correspondence Address: BAKER & MCKENZIE LLP, 711 LOUISIANA, SUITE 3400, HOUSTON, TX, 77002-2716, US

(21) Appl. No.: 11/017,272

(22) Filed: Dec. 20, 2004

(30) Foreign Application Priority Data
Dec. 23, 2003 (EP) 03425821.0

(51) Int. Cl. G01N 27/447; G01N 27/453

(52) U.S. Cl. 204/450; 204/600

(57) ABSTRACT

A microfluidic device includes an inlet reservoir, for receiving electrically charged substances dispersed in a fluid medium, a microfluidic circuit in fluidic connection with the inlet reservoir, and an electric transport device for moving the electrically charged substances along the microfluidic circuit. The electric transport device comprises a number of conductive regions arranged along the microfluidic circuit and separated by regions of opposite type, said regions of conductivity electrically connected to a voltage source for providing pulsed voltage that carries charged substances along the microfluidic circuit.

### PRIOR RELATED APPLICATIONS

This application claims priority to application EP03425821.0, filed on Dec. 23, 2003.

### STATEMENT REGARDING FEDERALLY SPONSORED RESEARCH OR DEVELOPMENT

Not applicable.

### REFERENCE TO A COMPACT DISK APPENDIX

Not applicable.

### FIELD OF THE INVENTION

The present invention relates to a microfluidic device and to a method for transporting electrically charged substances through a microchannel of a microfluidic device.

### BACKGROUND OF THE INVENTION

As is known, microfluidic devices may be exploited in a number of applications, and are particularly suited to be used as chemical or biological microreactors. Thanks to the design flexibility allowed by semiconductor micromachining techniques, single integrated devices have been made that are able to carry out individual process steps or even an entire process.

In particular, an integrated microreactor is usually provided with a microfluidic circuit, comprising a plurality of processing chambers in mutual fluidic connection through microchannels. In the most advanced integrated microfluidic devices the microchannels are buried in a substrate and/or in an epitaxial layer of a semiconductor chip. Substances to be processed, which are typically dispersed in a fluid, are supplied to one or more inlet reservoirs of the microfluidic circuit and are moved therethrough. Chemical reactions take place along the microfluidic circuit, either in the processing chambers or in the microchannels.

For example, integrated microfluidic devices are widely employed in biochemical processes, such as nucleic acid and protein analysis (such microreactors are also called “Labs-On-Chip”). In this case, a microfluidic device may comprise mixing chambers, lysis chambers, heating chambers, dielectrophoretic cells, amplification chambers, detection chambers, capillary electrophoresis channels, heaters, sensors, micropumps, and the like (see e.g., U.S. Patent Publication Nos. 20040132059, 20040141856, 20010024820, 20020017660, 20030057199 and 20020045244, all related patents or applications, each incorporated by reference in their entirety).

A general problem to be addressed in microfluidic device design is how the substances of interest can be moved through the microfluidic circuit. According to a known solution, a controlled pressure difference is applied across the inlet reservoir and a downstream end portion of the microfluidic circuit. Hence, the fluid medium, which contains the substances to be processed, flows from the inlet reservoir toward the downstream end and transports the substances through the microfluidic circuit. In practice, the pressure difference may be obtained by using either a force pump, such as a diaphragm pump, coupled to an upstream portion of the microfluidic circuit, or a suction pump, e.g. a vacuum pump, coupled to the downstream end portion of the microfluidic circuit.

However, the use of pumps provides some drawbacks. In the first place, pumps can be bulky and require a large area on the microreactor chip. Second, fluidic coupling between the pump and the microfluidic circuit can be difficult to accomplish and the device may leak. This is particularly true of the diaphragm pumps, which are also the most common integrated pumps. Other kinds of pumps, such as servo-controlled or hand-operated plunger pumps, do not suffer from leakage, but cannot be integrated on a chip by current microfabrication technology.

### SUMMARY OF THE INVENTION

The aim of the present invention is to provide a microfluidic device and a method for transporting electrically charged substances through a microchannel of a microfluidic device that are free from the above described drawbacks.

The present invention provides microfluidic devices and a method for transporting electrically charged substances through a microchannel of a microfluidic device, as defined in claims 1, 16, and 8, respectively. In a preferred embodiment, the device is an integrated device, but it need not be.

In particular, a microfluidic device includes an inlet reservoir, for receiving electrically charged substances, a detection chamber for detecting the results of whatever analysis is performed, and a microfluidic circuit in fluidic connection with both the inlet reservoir and a detection chamber. An electric transport device is arranged along the microfluidic circuit and moves the electrically charged substances along the microfluidic circuit.

The electric transport device employs a plurality of separated conductive regions, for example of N+-type, extending through the structural layer above the microfluidic circuit and transverse to the path of the microfluidic circuit. A voltage source periodically supplies voltage pulses of different amplitude to each conductive region to cause a travelling voltage wave that carries charged molecules with it.

In one embodiment, the microfluidic circuit comprises a “buried channel,” as defined and described in U.S. Pat. No. 6,770,471, U.S. Pat. No. 6,673,593, U.S. 20040096964, U.S. 20040227207, U.S. Pat. No. 6,710,311, U.S. Pat. No. 6,670,257, U.S. Pat. No. 6,376,291 and their related patents and applications (each incorporated by reference in their entirety). In another embodiment, the microfluidic circuit comprises additional processing chambers along its length, such cell lysis, cell purification and amplification chambers.

We have described the invention as it applies to nucleic acid, such as DNA, RNA, PNA and the like. Nucleic acid generally has a negatively charged backbone, with a single negative charge per nucleotide. It thus behaves predictably in an electric field, moving toward a positive charge. However, the invention can be applied to other charged molecules, including proteins or glycoproteins, lipids, and the like.

For a better understanding of the present invention, some preferred embodiments are now described, purely by way of non-limiting example, with reference to the attached drawings.

### BRIEF DESCRIPTION OF THE DRAWINGS

FIG. 1 is a top plan view of an integrated microfluidic device according to the present invention.

FIG. 2 is a cross section across the integrated microfluidic device of FIG. 1, taken along the line II-II of FIG. 1.

FIG. 3 is a cross section across the integrated microfluidic device of FIG. 1, taken along the line III-III of FIG. 1.

FIGS. 4a-4c are graphs showing plots of first quantities relating to the microfluidic device of Figure.

FIGS. 5a-5c are graphs showing plots of second quantities relating to the microfluidic device of FIG. 1.

FIGS. 6a and 6b show enlarged details of the graphs of FIGS. 5a, 5b, respectively.

FIG. 7 is a block diagram of a system including the microfluidic device of FIG. 1.

FIG. 8 is a graph showing plots of a third quantity relating to the microfluidic device of FIG. 1.

### DESCRIPTION OF EMBODIMENTS OF THE INVENTION

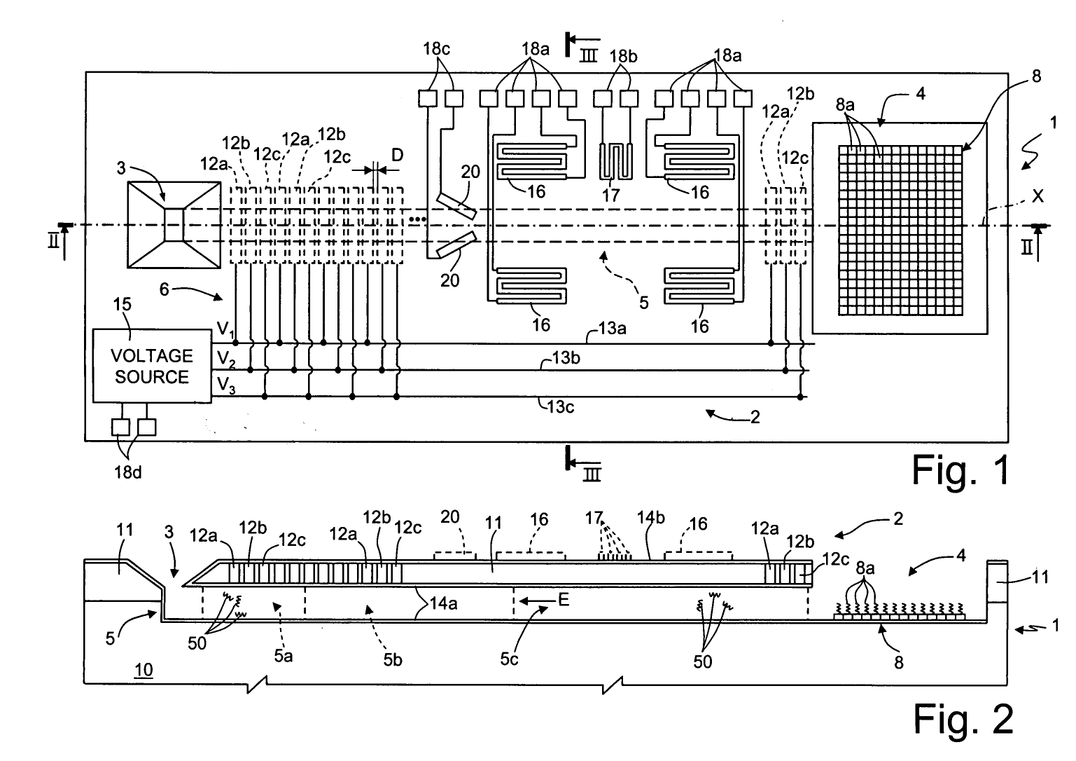

With reference to FIGS. 1 and 2, a semiconductor chip 1 houses a microfluidic device 2, in particular a chemical microreactor for nucleic acid analysis in the embodiment hereinafter described. The microfluidic device 2 comprises an inlet reservoir 3, open at an upper surface of the chip 1, a detection chamber 4, and a microfluidic circuit 5, fluidly coupling the inlet reservoir 3 and the detection chamber 4. The microfluidic device 2 is provided with an electric transport device 6, for moving electrically charged substances dispersed in a fluid medium away form the inlet reservoir 3 through the microfluidic circuit 5 and toward the detection chamber 4.

The inlet reservoir 3 is open at an upper surface of the chip 1. Accordingly, the inlet reservoir 3 is accessible from outside the device 1 for supplying a raw biological sample that has been preliminarily mixed with suitable reagents for carrying out a biochemical process.

The detection chamber 4 accommodates a microarray 8 of probes 8a for selective detection of predetermined substances in the biological sample. In an embodiment, the probes 8a include respective single stranded DNA grafted to a bottom wall of the detection chamber 4.

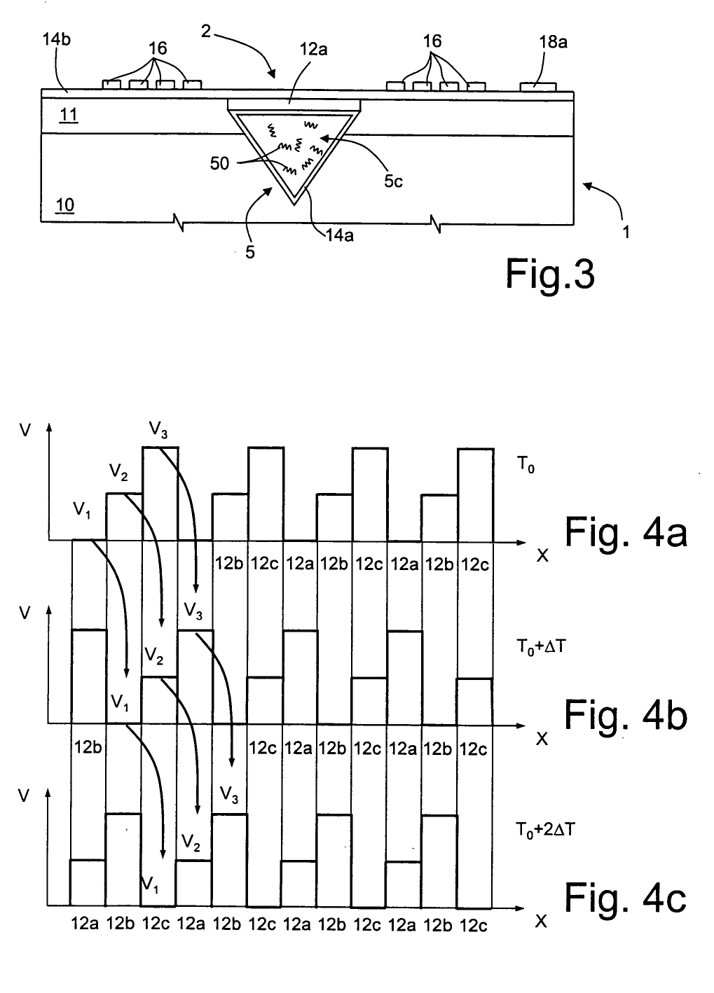

The microfluidic circuit 5 is in the form of a microchannel buried inside the chip 1. Processing chambers 5a-5c are formed within respective sections of the microfluidic circuit 5. In particular, the microfluidic circuit 5 comprises a lysis chamber 5a, a dielectrophoretic cell 5b, and an amplification chamber 5c, for executing an amplification process, such as PCR (Polymerase Chain Reaction). The amplification chamber 5c communicates in the detection chamber 4 for detecting the resulting amplicon. In practice, the microfluidic circuit 5 defines a buried microchannel, preferably having triangular cross-section, as shown in FIG. 3.

In greater detail, the processing chambers 5a-5c extend within a substrate 10 of the chip 1, here of P-type, and are upwardly delimited by an epitaxial layer 11, also of P-type. Preferably, the portions of the substrate 10 and of the epitaxial layer 11 which delimit the microfluidic circuit 5 are coated with a thin silicon dioxide layer 14a, e.g. of between 0.1 μm and 1 μm. However, other coatings may be applied, as appropriate for the application, provided the coating prevents deleterious interaction with the chemicals being processed in the microreactor. A further thin insulating layer 14b is formed on the epitaxial layer 11.

Heating elements 16 and a temperature sensor 17 are arranged on the insulating layer 14b above the amplification chamber 5c and are thermally coupled to the epitaxial layer 11 (conductive regions 12a, 12b, and 12c may continue, but are not drawn in this region for simplicity). Via respective pads 18a, 18b, the heating elements and the temperature sensors are electrically connected to an external power source and to a processing unit for controlling a temperature inside the amplification chamber 5c according to predetermined temperature profiles, as explained later on in the description. In one embodiment, the heaters 16 and the temperature sensor 17 are beside the amplification chamber 5c. In another embodiment (here not illustrated), the heaters 16 and the temperature sensor 17 are arranged across the amplification chamber 5c.

Dielectrophoresis electrodes 20 are arranged on the insulating layer 14b above the dielectrophoresis cell 5b and are connected to a processing unit (here not shown) via pads 18c.

The electric transport device 6 comprises a voltage source 15 and a plurality of conductive regions 12a, 12b, 12c (at least three), of N+-type, extending through the epitaxial layer 11 above the microfluidic circuit 5. More precisely, the conductive regions 12a, 12b, 12c are spaced apart from each other by a constant distance D, which is around the depth of the microfluidic circuit 5 and preferably of between 2 μm and 100 μm, more preferably greater than μm (the figures are not drawn to scale).

Furthermore, the conductive regions 12a, 12b, 12c are arranged in a linear array along the path of the microfluidic circuit 5 (i.e. along a longitudinal axis X of the microfluidic circuit 5). As to this point, in the embodiment of FIGS. 1 and 2, the microfluidic circuit 5 extends along a substantially rectilinear path. However, it is understood that the microfluidic circuit 5 may have a plurality of non-aligned sections as well (e.g., rectilinear sections forming right angles). In such case, the conductive regions 12 are arranged in an array having a plurality of sections, each running along the path (longitudinal axis) of a respective section of the microfluidic circuit 5.

The conductive regions 12a, 12b, 12c are connected by three conductive lines 13a, 13b, 13c alternately every three. In the example shown, for reasons of clarity, the conductive regions electrically connected by the conductive line 13a are denoted by 12a; the conductive regions electrically connected by the conductive line 13b are denoted by 12b; and the conductive regions electrically connected by the conductive line 13c are denoted by 12c.

The voltage source 15 has three output terminals, each connected to their respective conductive lines 13a, 13b, 13c and is connected to a processing unit (not shown in FIGS. 1-3) via pads 18d. The voltage source 15 periodically supplies three voltage pulses V1, V2, V3 of different amplitude to each conductive line 13a, 13b, 13c, and in turn to the conductive regions 12a, 12b 12c, so that the voltage levels are phase-shifted by 120° with respect to each other at any time. Each conductive line 13a, 13b, 13c sequentially receives the highest, the intermediate, and the lowest of the voltage pulses V1, V2, V3, in a wave like pattern.

Hence, at an initial time T0 voltage pulses V1, V2, V3 are provided on the conductive lines 13a, 13b, 13c, respectively. As an example, the voltage pulses V1, V2, V3 are of 0 V, 5 V and 10 V, respectively. After a time interval ΔT has elapsed (e.g. 5 ms), the conductive lines 13a, 13b, 13c receive the voltage pulses V3, V1, V2, respectively. Then, the conductive lines 13a, 13b, 13c receive the voltage pulses V2, V3, V1, respectively. The voltage pulses V1, V2, V3 are thus periodically supplied to the conductive regions 12a, 12b, 12c.

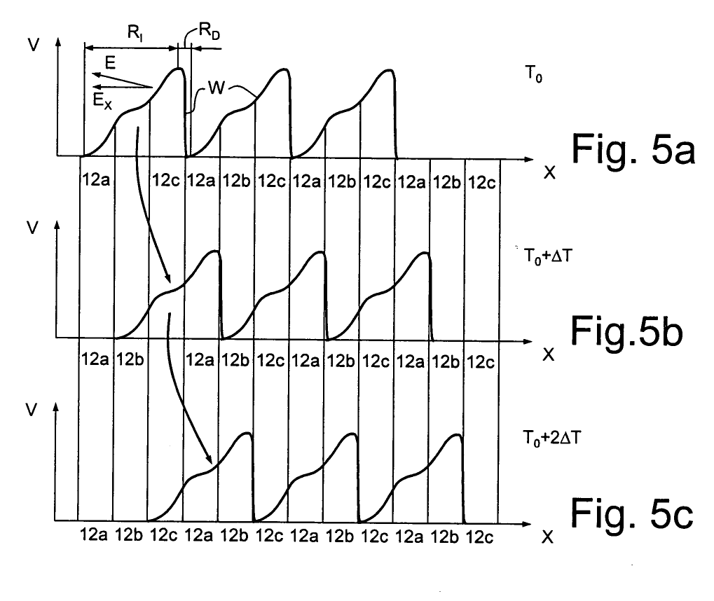

As shown in FIGS. 4a-4c and 5a-5c, a non-uniform voltage distribution is thus established along the path of the microfluidic circuit 5 and is associated with an electric field E which rises therein. The voltage distribution is periodic both in time and in space, along the microfluidic circuit 5.

The voltage pulses V1, V2, V3, are supplied periodically every three time intervals ΔT by the voltage source 15 (thus having a period equal to 3×ΔT). Moreover, at any time the voltage distribution is repeated every three conductive regions 12a, 12b, 12c. More precisely, at the initial time T0 (FIG. 4a), the conductive regions 12a, 12b, 12c, respectively receive the voltage pulses V1, V2, V3. At time T0+ΔT (FIG. 4b), the conductive regions 12a, 12b, 12c, respectively receive the voltage pulses V3, V1, V2; and at a time T0+2ΔT (FIG. 4c) the conductive regions 12a, 12b, 12c receive the voltage pulses V2, V3, V1.

The result is that voltage waves W are created inside the microfluidic circuit 5, and are shifted along its longitudinal axis X from the inlet reservoir 3 toward the detection chamber 4 (FIGS. 5a-5c schematically show the voltage distribution inside the microfluidic circuit 5, in particular along the longitudinal axis X). The voltage distribution is asymmetric in the voltage waves W, which have respective increasing voltage regions R_{I}, on the side of the inlet reservoir 3, and decreasing voltage regions R_{D}, on the side of the detection chamber 4 (voltage is considered to increase or decrease in the direction from the side of the inlet reservoir 3 toward the side of the detection chamber 4). More specifically, the voltage gradually increases in increasing voltage region R_{I}, which roughly extend over segments of the microfluidic circuit 5 corresponding to conductive regions 12a, 12b, 12c receiving the voltage pulses V1, V2, V3, respectively. On the contrary, the voltage abruptly falls to around zero in decreasing voltage regions R_{D}, which are between two adjacent conductive regions 12a, 12b, 12c receiving the voltage pulse V3 (highest voltage pulse) and the voltage pulse V1 (lowest voltage pulse), respectively. Hence, in each voltage wave the highest voltage is on the side of the detection chamber 4. Obviously, the wave would be reversed if one wished to move a positively charged molecule in the direction of the outlet reservoir.

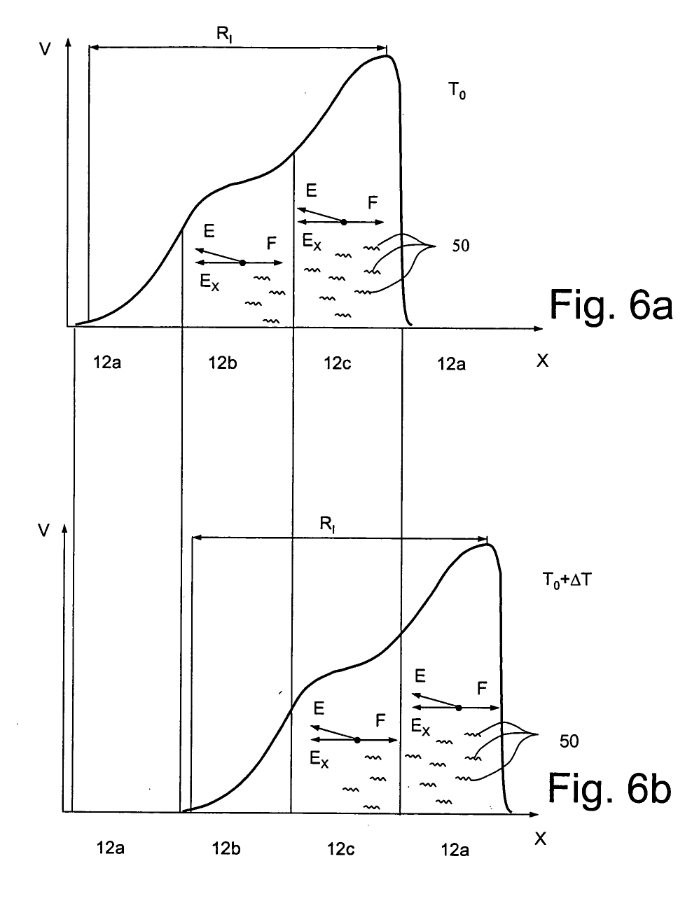

The electric field E has a non-uniform time-variant distribution inside the microfluidic circuit 5. In particular, at least a component E_{X} of the electric field E is parallel to the longitudinal axis X of the microfluidic circuit 5 and has uniform orientation within each increasing voltage region R_{I} (toward the inlet reservoir 3, in the example described; see also FIGS. 6a and 6b). The component E_{X} of the electric field E has opposite orientation in the decreasing voltage regions R_{D} (not shown for simplicity). Furthermore, the electric field E is shifted toward the detection chamber 4 together with the increasing voltage regions R.

In order to carry out a nucleic acid analysis through the microfluidic device 2, the microfluidic circuit 5 is filled with a fluid medium (e.g. water and buffer) and a fluid organic sample containing substances to be processed (e.g. nucleated cells having DNA molecules) is provided in the inlet reservoir 3. DNA molecules are first extracted from the nuclei of the cells, and may be denatured and amplified as desired. Hence, the DNA 50 is subjected to the action of the electric field E in the microfluidic circuit 5 as soon as the voltage source 15 is activated, and tends to concentrate in the vicinity of the conductive regions 12a, 12b, 12c having the highest voltages (i.e. the voltage V3, see FIG. 4a-4c). In fact, high voltage regions correspond to low potential energy regions for negatively charged particles. As already explained, the voltage pulses V1, V2, V3 are periodically supplied to each of the conductive regions 12a, 12b, 12c and immediately adjacent conductive regions 12a, 12b, 12c receive voltage pulses with uniform phase-shift of 120°.

The voltage pulses V1, V2, V3 provided to the conductive regions 12a, 12b, 12c are shifted toward the detection chamber 4, and the DNA 50 moves accordingly. Owing to the shift and to the asymmetric voltage distribution in each voltage wave W, the DNA 50 experiences a uniformly oriented electric field component Ex and, hence, uniformly oriented force F (FIGS. 6a, 6b). Thus, the DNA 50 is carried away to the regions of minimum potential energy, which move toward the detection chamber 4, too.

In particular, the force F applied on the DNA 50 is directed against the orientation of the electric field E because of its negative charge. DNA 50 that may possibly escape a voltage wave W would be attracted and captured again within the same or the following voltage wave W (because of the opposite orientation of the electric field E outside the increasing voltage regions R_{I}).

In practice, the DNA 50 is “grasped” by the traveling electric field E and a net transport thereof results toward the detection chamber 4, due to the shift of the electric field E. Hence the DNA 50 is processed as traveling through the processing chambers 5a-5c of the microfluidic circuit 5, and are collected in the detection chamber 4.

DNA 50 travels under the effect of the electric field E irrespective of the motion of the fluid medium. Depending on the presence of charged molecules, the fluid medium may be quiet or travel either with or against the orientation of the electric field E. It is also to be noticed that the thin silicon dioxide layer 14 prevents electron exchange between the conductive regions 12a, 12b, 12c and the fluid medium, thus reducing currents flowing therethrough, especially in the case of high ion concentration.

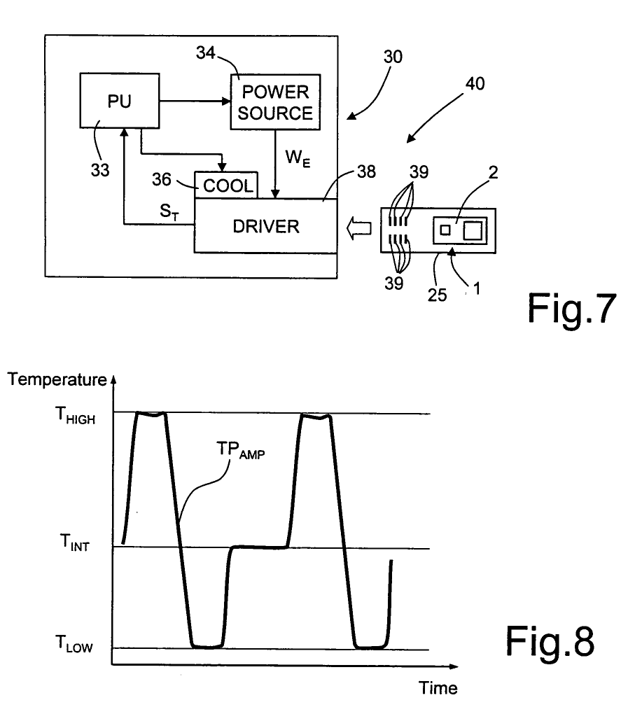

In one embodiment, the chip 1 including the microfluidic device 2 is mounted on a board 25 for insertion in a computer system 30 (see FIG. 7). The computer system 30 comprises a processing unit 33, a power source 34 controlled by the processing unit 33 and a driver device 38. The board 25 with the chip 1 and the microfluidic device 2 is removably inserted in the driver device 38, for selective coupling to the processing unit 33 and to the power source 34. To this end, the board 25 is provided with contacts 39 connected with respective pads 18a-18d of the microfluidic device 2 (here not shown, see FIG. 1). The driver device 38 also includes a cooling element 36, e.g. a Peltier module, which is controlled by the processing unit 33 and is coupled to the microfluidic device 2 when the board 25 is loaded in the driver device 38. The computer system 30 and the microfluidic device loaded therein form a biochemical analysis apparatus 40.

A biochemical process including PCR amplification of the DNA in the amplification chamber 5c may be carried out by the biochemical analysis apparatus 30. To this end, the processing unit 33 controls the voltage source 15 to move the sample under analysis through the microfluidic circuit 5 toward the detection chamber 4, including stays of suitable duration in each of the processing chambers 5a-5c. Single processing steps are thus carried out. In particular, the processing unit 33 controls the power source 34 and the cooling element 36 to deliver electric power W_{E} to the heaters 16 and to cyclically heat and cool off the sample supplied in the amplification chamber 5c according to a desired amplification temperature profile. Even during PCR amplification cycles, temperature is substantially uniform in the surroundings of the amplification chamber 5c, due to the thermal conductivity of the epitaxial layer 11 and of the substrate 10 and to the small thickness of the insulation layer 14b. Accurate control of the temperature profile is achieved based on a temperature signal S_{T} supplied by the temperature sensor 17. Any suitable control method may be implemented by the processing unit 33.

FIG. 8 shows an example of an amplification temperature profile TPAMP in the detection chamber 4 during a PCR amplification cycle. At T_{HIGH} (94° C. for 10 s to 60 s), double stranded DNA is first denatured, i.e. separated into single strands. Then the primers hybridize to their complementary sequences on either side of the target sequence (T_{LOW}, selected in the range of 50° C. to 70° C. for 10 s to 60 s). Finally, DNA polymerase extends each primer, by adding nucleotides that are complementary to the target strand (T_{INT}, 72° C. for 10 s to 60 s). This doubles the DNA content and the cycle is repeated until sufficient DNA has been synthesized. The heating rate is preferably of 5-7° C./s; the cooling rate is preferably greater than 10° C./s.

Once a predetermined number of amplification cycles have been completed and a sufficient amount of DNA is available, the sample is moved to the detection chamber 4 for hybridization of the microarray 8 and detection (e.g. by an optical reader included in the driver device 8 and here not shown).

It is clear from the above description that the invention provides several advantages. In the first place, the need for a hydraulic pump is overcome, since DNA is transported by way of electrostatic forces. Therefore, smaller and cheaper microfluidic devices may be made. In fact, the electrostatic transport device does not increase significantly the overall dimensions of the chip. Moreover, only standard microfabrication manufacturing steps are required. Further, without the need for a pump, leakage problems are eliminated, so that a minimum volume of reactants may be used.

Finally, it is clear that numerous modifications and variations may be made to the chemical microreactor and to the method described and illustrated herein, all falling within the scope of the invention, as defined in the attached claims.

First of all, although the invention is especially suited for microreactors for biochemical processes, its exploitation is not limited to example above described DNA analysis. It may be used for moving any electrically charged molecule or particle dispersed in a fluid medium through a microfluidic circuit or channel.

In particular, the electric transport device can be used also to cause a net transport of positively charged molecules or particles (such as proteins) through the microfluidic circuit. For example, the conductive regions may be supplied with periodical, phase-shifted negative voltages so as to produce negative voltage waves traveling toward the outlet reservoir and having the lowest voltages on the side of the outlet reservoir. Positively charged particles are thus attracted around the lowest voltage waves, since low voltage corresponds to low potential energy for positively charged particles. The negative voltage waves are then shifted toward the outlet reservoir, thereby transporting positively charged particles in the same direction. In such case, the conductive regions may be made as P+-type diffusions through a N-type epitaxial layer.

As an alternative, positive voltage waves traveling toward the inlet reservoir may be provided, which produce net transport of positively charged particles toward the outlet reservoir. Moreover, more than three voltage pulses may be provided to adjacent conductive regions. In general, the voltage source may provide N voltage pulses on N conductive lines, so that the voltage levels on the conductive lines are phase-shifted of 360°/N with respect to each other, in this case, each conductive line is connected to a conductive region every N.

1.) A microfluidic device, comprising an inlet reservoir, for receiving electrically charged substances dispersed in a fluid medium, and a microfluidic circuit fluidly coupled to said inlet reservoir, characterized in that it comprises an electric transport device, arranged along said microfluidic circuit for moving said electrically charged substances along said microfluidic circuit away from said inlet reservoir.

2) The microfluidic device of claim 1, wherein said electric transport device comprises at least three conductive regions, arranged adjacent along said microfluidic circuit, and periodic biasing means for periodically biasing said conductive regions according to a predetermined sequence.

3) The microfluidic device of claim 2, wherein said periodic biasing means comprises a voltage source, having a number N of outputs and periodically supplying N voltage pulses having different amplitudes on said outputs, such that voltage levels on said outputs are phase-shifted with respect to each other.

4) The microfluidic device of claim 3, wherein each of said outputs is connected to one conductive region every N and immediately adjacent conductive regions are connected to different outputs.

5) The microfluidic device of claim 4, wherein immediately adjacent conductive regions are connected to outputs providing voltage pulses which are phase-shifted 360°/N.

6) The microfluidic device of claim 5, wherein the voltage levels on said outputs are uniformly phase-shifted.

7) The microfluidic device of claim 6, wherein said microfluidic circuit is housed in a semiconductor chip and is upwardly delimited by an epitaxial layer having a first type of conductivity, and wherein said conductive regions extend through said epitaxial layer and have a second type of conductivity, opposite to said first type of conductivity.

8) A method for moving electrically charged substances dispersed in a fluid medium through a microfluidic circuit of a microfluidic device, comprising the step of providing an electric field within said microfluidic circuit, a component of said electric field being directed substantially parallel to an axis of said microfluidic circuit and having uniform orientation at least in a region of said a microfluidic circuit.

9) A method of claim 8, further comprising the step of shifting said electric field along said microfluidic circuit.

10) A method of claim 9, wherein said step of providing an electric field comprises establishing a non-uniform voltage distribution within said microfluidic circuit, said non-uniform voltage distribution being periodic in time and in space, along said microfluidic circuit.

11) A method of claim 10, wherein said step of establishing a non-uniform voltage distribution comprises periodically providing a number N of voltage pulses at space intervals along said microfluidic circuit, according to a predetermined sequence.

12) A method of claim 11, wherein said step of periodically providing a number N of voltage pulses comprises periodically providing said voltage pulses to at least three conductive regions arranged adjacent along said microfluidic circuit and spaced apart by said space intervals, such that immediately adjacent conductive regions receive said voltage pulses with a phase-shift of 360°/N.

13) A method of performing a biological test, wherein a biological fluid is applied to the integrated microreactor of claim 7 and a biological test is performed.

14) A method of claim 13, wherein the biological test is amplification.

15) A method of claim 14, wherein the amplification is DNA amplification.

16) A microfluidic device, comprising:
a) a semiconductor body;
b) an inlet reservoir in said semiconductor body, for receiving a biological sample including an electrically charged molecule;
c) a detection chamber in said semiconductor body;
d) a microfluidic circuit fluidly coupled to said inlet reservoir and to said detection chamber and including one or more processing chambers;
e) an electric transport device comprising a plurality of conductive regions arranged sequentially and adjacent said microfluidic circuit;
f) a voltage source electrically connected to said conductive regions for providing a pulsed voltage to move said electrically charged molecule along said microfluidic circuit.

17) The microfluidic device of claim 16, wherein said processing chambers include an amplification chamber for nucleic acid amplification.

18) The microfluidic device of claim 17, comprising heating elements and a temperature sensor associated with said amplification chamber, wherein said heating elements are connected to an external power source heating said biological sample in said amplification chamber.

19) The microfluidic device according to claim 18, wherein said detection chamber includes an array of probes for nucleic acid detection.

20) The microfluidic device according to claim 19, wherein said microfluidic circuit includes a microchannel buried in said semiconductor body.

21) The microfluidic device according to claim 16, wherein said conductive regions are spaced apart from each other by a distance which is approximately equal to a depth of said microfluidic circuit.

22) The microfluidic device according to claim 16, wherein said conductive regions are spaced apart from each other by at least 2 μm.

23) The microfluidic device according to claim 22, wherein said distance is at least 10 μm.
